(19) United States
(12) Patent Application Publication
(10) Pub. No.: US 2003/0122810 A1
(43) Pub. Date: Jul. 3, 2003

(54) Method and apparatus to adjust the brightness of a display screen

(76) Inventors: Aaron M. Tsirkel, San Jose, CA (US); Gary R. Bradski, Palo Alto, CA (US); Robert L. Davies, Fremont, CA (US)

Correspondence Address: INTEL CORPORATION, P.O. BOX 5326, SANTA CLARA, CA, 95056-5326, US

(21) Appl. No.: 10/039,590

(22) Filed: Dec. 31, 2001

(51) Int. Cl. G09G 5/00

(52) U.S. Cl. 345/207

(57) ABSTRACT

A computer system may include a camera to perform various video imaging functions. The camera may also be used to measure ambient light. The brightness of the display screen of the computer system may be adjusted in response to this measurement of ambient light. For example, the display screen brightness may be increased if the ambient light increases, and decreased if the ambient light decreases. In addition, in accordance with one embodiment of the present invention, the position of the user may be determined, and the ambient light may be measured in the vicinity of the user.

The present invention relates to computer systems and more particularly to a power savings technique in which ambient light may be measured and the brightness of a display screen of the computer system may be adjusted accordingly.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers. Computer systems typically include one or more processors. A processor may manipulate and control the flow of data in a computer. To provide more powerful computer systems for consumers, processor designers strive to continually increase the operating speed of the processor. Unfortunately, as processor speed increases, the power consumed by the processor tends to increase as well. Historically, the power consumed by a computer system has been limited by two factors. First, as power consumption increases, the computer tends to run hotter, leading to thermal dissipation problems. Second, the power consumed by a computer system may tax the limits of the power supply used to keep the system operational, reducing battery life in mobile systems and diminishing reliability while increasing cost in larger systems.

One approach to reducing overall power consumption of a computer system is to change the focus of power reduction from the processor to other components that have a significant impact on power. For example, display screens of computer systems typically consume a significant amount of power. For many backlit liquid crystal display (LCD) screens, increasing the brightness of the display screen typically increases its power consumption, and decreasing the brightness of the display screen typically decreases its power consumption. Therefore, it is typically in a user's best interest to operate the display screen at a low brightness level, while still providing comfortable viewing, to reduce power consumption.

To accomplish this, the user would typically need to manually readjust the brightness of the display screen each time ambient lighting conditions change. For today's mobile systems, ambient lighting conditions may change regularly, placing undue burden on the user to continually readjust the display screen brightness. Unless these adjustments are made, however, battery life will suffer. The present invention addresses this and other problems associated with the prior art.

### BRIEF DESCRIPTION OF THE DRAWINGS

The present invention is illustrated by way of example and not limitation in the accompanying figures in which like references indicate similar elements and in which:

FIG. 1 includes a computer system formed in accordance with an embodiment of the present invention;

FIG. 2 includes a computer system formed in accordance with an embodiment of the present invention;

FIG. 3 includes a circuit formed in accordance with an embodiment of the present invention;

FIG. 4 includes an image in accordance with an embodiment of the present invention; and

FIG. 5 includes a flow chart showing a method of an embodiment of the present invention.

### DETAILED DESCRIPTION

In accordance with an embodiment of the present invention, a computer system may include a camera to perform various video imaging functions. The camera may also be used to measure ambient light. The brightness of the display screen of the computer system may be adjusted in response to this measurement of ambient light. For example, the display screen brightness may be increased if the ambient light increases, and decreased if the ambient light decreases. In addition, in accordance with one embodiment of the present invention, the position of the user may be determined, and the ambient light may be measured in the vicinity of the user.

A more detailed description of embodiments of the present invention, including various configurations and implementations, is provided below.

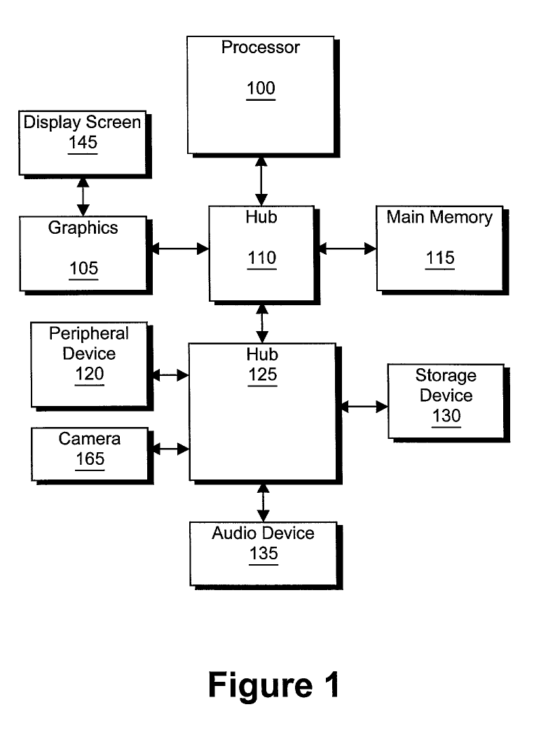

FIG. 1 includes a computer system that may be formed in accordance with an embodiment of the present invention. As shown, the computer system may include a processor 100 coupled to hub 110. Processor 100 may communicate with graphics controller 105, main memory 115, and hub 125 via hub 110. Graphics controller 105 may be coupled to display screen 145. Hub 125 may couple peripheral device 120 (which may be any one or more of a number of input/output devices), storage device 130, audio device 135, and camera 165 to hub 110.

In accordance with one embodiment of the present invention, camera 165 of FIG. 1 may serve alternate purposes beyond the ambient light measurement purpose described herein. For example, camera 165 may enable video imaging functions such as still photo capturing, video recording, teleconferencing, etc. Thus, camera 165 may be distinguished from a photocell used to measure ambient light. A computer system may need to be redesigned to accommodate a photocell for purposes of measuring ambient light whereas the system of FIG. 1 may already be designed to accommodate camera 165 for video imaging functions.

A method of an embodiment of the present invention may be implemented by the computer system of FIG. 1 programmed to execute instructions associated with the method. In addition, the video imaging functions described above may be implemented by the computer system of FIG. 1 programmed to execute instructions associated with those functions as well. These instructions may reside, at least in part, in any machine-readable medium such as a magnetic disk (e.g. a hard drive or floppy disk), an optical disk (e.g. a CD or DVD), a semiconductor device (e.g. Flash, EPROM, or RAM), or a carrier wave (e.g. an electrical or wireless data signal), all of which are collectively represented by storage device 130 of FIG. 1.

In accordance with an embodiment of the present invention, a computer system may include more or fewer components than those shown in FIG. 1, and the components of FIG. 1 may be partitioned differently. For example, multiple components may be integrated into a single component, and single components may be divided into multiple components. Note that the term “processor” may be used herein to refer to one or more of a central processing unit, a processor of a symmetric or asymmetric multiprocessing system, a digital signal processor, a micro-controller, etc.

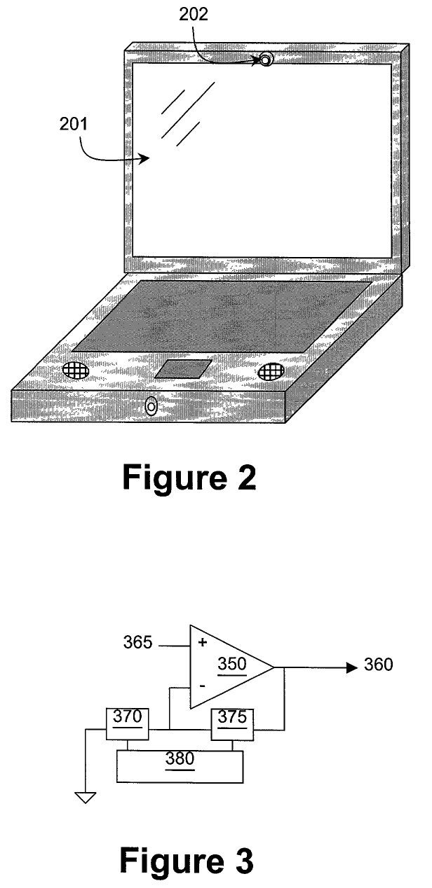

FIG. 2 includes a “clam shell” mobile computer system (e.g. a laptop, notebook, sub-notebook, etc.) formed in accordance with an embodiment of the present invention. The computer system includes a flat panel display screen 201, and a camera 202. Camera 202 may be used to provide an image to be analyzed to measure ambient light, as described in more detail below. In accordance with an alternate embodiment of the present invention, camera 202 may be located elsewhere on the computer system chassis or may be separated from the chassis via a wired or wireless connection.

FIG. 3 includes a circuit formed in accordance with an embodiment of the present invention. Output 360 of op amp 350 is fed back to the inverting input of the op amp via resistor 375, and the inverting input of the op amp is coupled to ground (or Vss) via resistor 370. Input voltage 365 is provided to the non-inverting input of op amp 350. Resistors 370 and 375 are digitized resistors, the resistances of which may be set by values entered into control register 380 (which may be implemented as a single or multiple registers). The values may be entered into control register 380 directly by an application specific circuit, without intervention by the processor of the system, thereby placing output 360 under hardware control. Alternatively, the values may be entered into control register 380 directly or indirectly by the processor of the computer system, thereby placing output 360 under software control.

In accordance with an embodiment of the present invention, a stable reference voltage, Vref, may be provided as input voltage 365 of FIG. 3. Output 360 may be determined by the equation Vref×(1+375/370), where 375 and 370 are the resistances of resistors 375 and 370, respectively. For one embodiment of the present invention, the circuit of FIG. 3 may be used to configure the brightness of a display screen of the computer system. For example, the circuit of FIG. 3 may be used to set and adjust a backlight voltage level for the display screen.

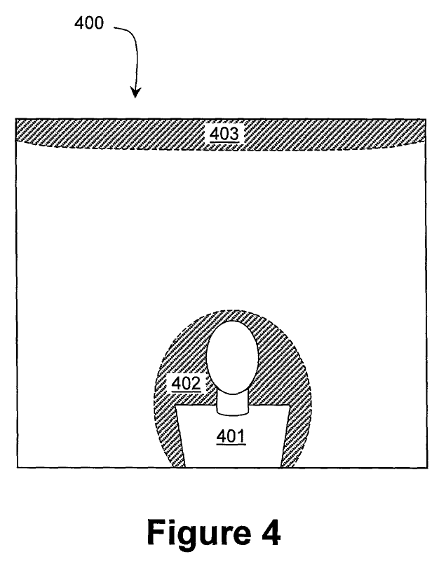

FIG. 4 includes image 400 formed in accordance with an embodiment of the present invention. In accordance with an embodiment of the present invention, image 400 may be provided by the camera of the computer system to a storage device for access and analysis by a processor of the system. As shown, image 400 may include an image of user 401 along with the surrounding ambient. Highlighted in image 400 is ambient region 402 in the vicinity of user 401, and ambient region 403 near an upper portion of the image.

For one embodiment of the present invention, vicinity 402 of FIG. 4 may be located by first determining the position of user 401 in image 400, then extending the field surrounding user 401 by a reasonable distance. The position of user 401 may be determined using skin tone detection, edge detection, motion detection, or other image recognition techniques. Note that vicinity 402 may or may not include user 401.

In accordance with one embodiment of the present invention, ambient light may be measured for all of image 400 of FIG. 4. For an alternate embodiment of the present invention, ambient light may be measured in the vicinity of user 401, including all of image 400 except ambient region 403. For another embodiment, ambient light may be measured in the vicinity of user 401 excluding all but vicinity 402. In accordance with an embodiment of the present invention, it may be found advantageous to measure ambient light in the vicinity of user 401, instead of throughout all of image 400, to improve accuracy. For example, suppose user 401 of FIG. 4 is operating the computer system in a bright office or on a sunny day while the user and the computer system are shaded. Because the computer system is shaded, a low luminance value should be calculated for the ambient light measurement. If the entire image is used to measure ambient light, however, an unduly high luminance value may be determined due to, for example, bright background sunlight or bright background office lights that may be captured in the image within region 403. By limiting the measured ambient light to the vicinity of the user, calculating these anomalous values may be avoided.

Thus, an embodiment of the present invention is further distinguished from an embodiment in which a photocell may be used to measure ambient light and adjust display screen brightness accordingly. A photocell may provide a single point indication of ambient light conditions, which may be prone to inaccuracies. Because a photocell does not provide an image, the measurement of ambient light by a photocell may not be refined, in the manner described above, to improve accuracy. In contrast, because a camera provides an image, ambient light may be more intelligently measured by analysis and processing of the image.

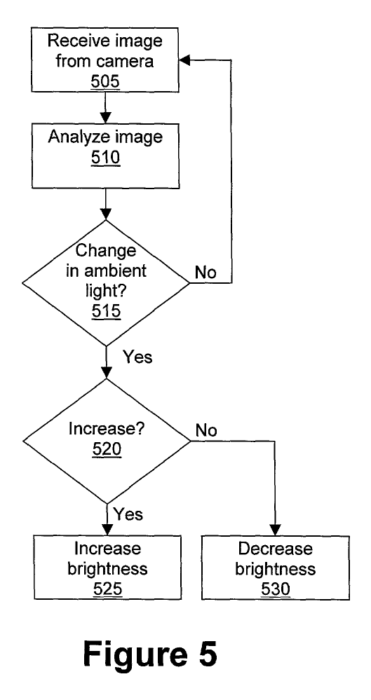

FIG. 5 includes a flow chart showing a method of an embodiment of the present invention. At block 505 an image is provided by a camera of the computer system for ambient light measurement and subsequent display image brightness adjustment. In accordance with an embodiment of the present invention, the image may be captured and provided by the camera on a predetermined, periodic basis. For example, the image may be provided multiple times per second, once per second, once per minute, multiple times per hour, etc. Alternatively, the image may be provided based on a user-controlled triggering event. For example, the image may be provided at the beginning of a user session (e.g. on boot up, logon, wake from a sleep state, etc.). If the camera is being used for video imaging, one or more frames of the video stream may be occasionally “borrowed” for the purpose of measuring ambient light in accordance with an embodiment of the present invention.

The image received from the camera at block 505 of FIG. 5 is then analyzed at block 510 by the computer system. This analysis may involve separating the image into luminance and chrominance portions, and measuring all or one or more portions of the luminance portion. For one embodiment of the present invention, multiple ambient light measurements from successive images may be taken and reconciled to improved measurement accuracy. Alternatively, multiple ambient light measurements from multiple portions of one or more images may be taken and reconciled to improve measurement accuracy. As described above, the position of the user in the image may be determined as part of this analysis.

After the image has been analyzed and the ambient light has been measured at block 510 of FIG. 5, it may be determined at block 515 if there has been a change in the ambient light. In accordance with one embodiment of the present invention, this may be accomplished by comparing the latest ambient light measurement from block 510 with a previous ambient light measurement. If no change is detected, the process may return to block 505 where, perhaps after a predetermined period of time, as described above, another image may be provided by the camera. If, however, a change in ambient light is detected, the process may proceed to block 520.

If, at block 520 of FIG. 5, it is determined that ambient light has increased in comparison to a prior measurement, the process may proceed to block 525 where the brightness of the display screen may be increased to provide visibility by compensating for the increased ambient light. The brightness may be increased in comparison to a previous brightness setting, and the amount of this increase may be proportional to the measured increase in ambient light. In accordance with one embodiment of the present invention, the display screen brightness may be increased to a user-defined upper limit.

If, at block 520 of FIG. 5, it is determined that ambient light has decreased in comparison to a prior measurement, the process may proceed to block 530 where the brightness of the display screen may be decreased to save power. The brightness may be decreased in comparison to a previous brightness setting, and the amount of this decrease may be proportional to the measured decrease in ambient light. In accordance with one embodiment of the present invention, the display screen brightness may be decreased to a user-defined lower limit.

In accordance with an embodiment of the present invention, blocks 525 and 530, as shown in FIG. 5, may be directed toward an embodiment in which the display screen may be a backlit LCD or a light emitting diode (LED) display. For an embodiment in which the display screen is a backlit LCD, adjusting screen brightness may involve adjusting the backlight brightness. For an embodiment in which the display screen is an LED display, adjusting screen brightness may involve adjusting the LED pixel brightness directly. For example, adjusting screen brightness for an LED may involve adjusting the luminance portion of the images to be displayed on the screen.

In accordance with an alternate embodiment of the present invention, a reflective or hybrid display screen may be used. For this embodiment, if it is determined that ambient light has increased in comparison to a prior measurement at block 520 of FIG. 5, the brightness of the display screen may be decreased to save power. If, on the other hand, it is determined that ambient light has decreased in comparison to a prior measurement at block 520 of FIG. 5, the brightness of the display screen may be increased to provide visibility.

This invention has been described with reference to specific exemplary embodiments thereof. It will, however, be evident to persons having the benefit of this disclosure that various modifications and changes may be made to these embodiments without departing from the broader spirit and scope of the invention. The specification and drawings are, accordingly, to be regarded in an illustrative rather than a restrictive sense.

What is claimed is:

1. A computer system, comprising:
a camera; and
a display screen, a brightness of which is to be adjusted in response to measuring ambient light using the camera.

2. The computer system of claim 1, wherein the brightness of the display screen is to be increased in response to measuring an increase in the ambient light.

3. The computer system of claim 2, wherein the brightness of the display screen is to be decreased in response to measuring a decrease in the ambient light.

4. The computer system of claim 1, wherein the ambient light is to be measured in a vicinity of a user.

5. The computer system of claim 1, wherein the brightness of the display screen is to be decreased in response to measuring an increase in the ambient light.

6. The computer system of claim 1, further comprising a storage device storing measurement code and adjustment code to be executed by the computer system, the measurement code to measure the ambient light and the adjustment code to adjust the brightness of the display screen in response thereto.

7. The computer system of claim 6, wherein the measurement code is to measure a luminance of the ambient light.

8. The computer system of claim 6, wherein the storage device further stores user position code to be executed by the computer system, the user position code to determine a position of a user, the measurement code to measure the ambient light in a vicinity of the user.

9. The computer system of claim 1, wherein the camera is to enable a video imaging function.

10. A method, comprising:
providing a computer system with a display screen and a camera, the camera to produce an image; and
enabling a brightness of the display screen to be adjusted in response to an analysis of the image.

11. The method of claim 10, wherein enabling the brightness of the display screen to be adjusted comprises enabling the brightness to be increased if it is determined that ambient light is increased

12. The method of claim 10, wherein enabling the brightness of the display screen to be adjusted comprises enabling the brightness to be decreased if it is determined that ambient light is increased

13. The method of claim 10, wherein the analysis includes measuring ambient light in a vicinity of a user.

14. The method of claim 10, wherein enabling the brightness of the display screen to be adjusted includes storing instructions in the computer system to adjust the brightness of the display screen.

15. The method of claim 14, wherein enabling the brightness of the display screen to be adjusted further includes storing instructions in the computer system to analyze the image.

16. The method of claim 10, wherein the analysis of the image includes determining a luminance of the image.

17. The method of claim 10, wherein the analysis of the image includes determining a user position in the image.

18. The method of claim 10, further comprising enabling the camera to provide a video imaging function.

19. A machine readable medium including machine readable instructions that, if executed by a computer system, cause the computer system to perform a method comprising:
analyzing an image to measure ambient light; and
adjusting brightness of a display screen in response to analyzing the image.

20. The medium of claim 19, wherein adjusting the brightness of the display screen comprises decreasing the brightness if the ambient light decreases.

21. The medium of claim 19, wherein adjusting the brightness of the display screen comprises increasing the brightness if the ambient light decreases.

22. The medium of claim 19, wherein the method further comprises determining a position of a user.

23. The medium of claim 22, wherein analyzing the image comprises measuring the ambient light in a vicinity of the user.

24. The medium of claim 19, wherein analyzing the image comprises measuring the ambient light in a vicinity of a user.

25. The medium of claim 19, wherein analyzing the image comprises determining a luminance of the ambient light.

26. The medium of claim 19, wherein the method further comprises a video imaging function using the image.
